(19) United States
(12) Patent Application Publication
(10) Pub. No.: US 2024/0376267 A1
(43) Pub. Date: Nov. 14, 2024

(54) POLYIMIDE RESIN MATERIAL FOR COLORLESS TRANSPARENT PROCESSED PRODUCT AND NOVEL POLYIMIDE

(71) Applicant: HONSHU CHEMICAL INDUSTRY CO., LTD., Chuo-ku, Tokyo (JP)

(72) Inventor: Ryota IMAI, Wakayama-shi (JP)

(21) Appl. No.: 18/560,832

(22) PCT Filed: Apr. 20, 2022
(86) PCT No.: PCT/JP2022/018280

§ 371 Date: Aug. 2, 2024

(30) Foreign Application Priority Data
May 21, 2021 (JP) 2021-085764
Sep. 15, 2021 (JP) 2021-150425

(51) Int. Cl. C08G 73/16; C08J 5/18

(52) U.S. Cl. CPC C08G 73/16; C08J 5/18; C08J 2379/08

(57) ABSTRACT

A polyimide resin material for a colorless transparent processed product, contains a polyimide having a repeating unit represented by general formula (1) below,

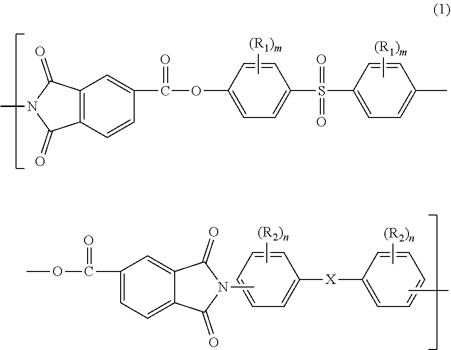

wherein X represents a direct bond or a sulfonyl group (—SO₂—), R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2. The polyimide resin material can be featured by high colorless transparency and also high heat resistance.

### TECHNICAL FIELD

The present invention relates to a polyimide resin material for a colorless transparent processed product and to a novel polyimide, the polyimide resin material containing a polyimide having a structure derived from a trimellitic anhydride ester of a bis(4-hydroxyphenyl)sulfone.

### BACKGROUND ART

Polyimide resin, which is obtained by the reaction of a tetracarboxylic dianhydride with a diamine, is generally an insoluble and infusible super heat-resistant resin and is characterized as being excellent in thermal oxidation resistance, heat resistance, radiation resistance, low-temperature resistance, chemical resistance, etc. Thus, polyimide resin is being used as a material or heat-resistant adhesive in the fields of electrical and electronic components such as insulating coating agents, insulating films, semiconductors, electrode-protecting films, and flexible printed circuit boards, aerospace equipment, transportation equipment, and the like. For example, in the fields of electrical and electronic components and the like, it has been studied to replace a glass substrate used in an image display unit such as a liquid crystal display or an OLED display with polyimide resin for the purpose of achieving a lighter and more flexible device. In addition, it has been studied to use polyimide resin as a cover window or an adhesive for bonding the cover window to a display in order to achieve a flexible shape that allows an image display unit of a device to be folded or rolled up.

Polyimide resin used in such applications is also required to have colorless transparency and further required to have high heat resistance so as to withstand a high-temperature process in a process for manufacturing an image display unit, but a practical polyimide resin material that satisfies all of the required physical properties is not yet known.

### CITATION LIST

### Patent Literature

PTL 1: International Publication No. 2017/169646
PTL 2: International Publication No. 2011/033751

### SUMMARY OF INVENTION

### Technical Problem

An object of the present invention is to provide a polyimide resin material having high colorless transparency and also having high heat resistance and to provide a novel polyimide having these properties.

### Solution to Problem

To achieve the above object, the present inventors have conducted intensive studies and found that a polyimide having a structure derived from a trimellitic anhydride ester of a bis(4-hydroxyphenyl)sulfone and a particular partial structure derived from a diamine has high colorless transparency and also has high heat resistance, thereby completing the present invention. Moreover, this polyimide has thermoplasticity and thus is useful also as a melt-processable material.

The present invention is as follows.

1. A polyimide resin material for a colorless transparent processed product, the polyimide resin material containing a polyimide having a repeating unit represented by general formula (1) below.

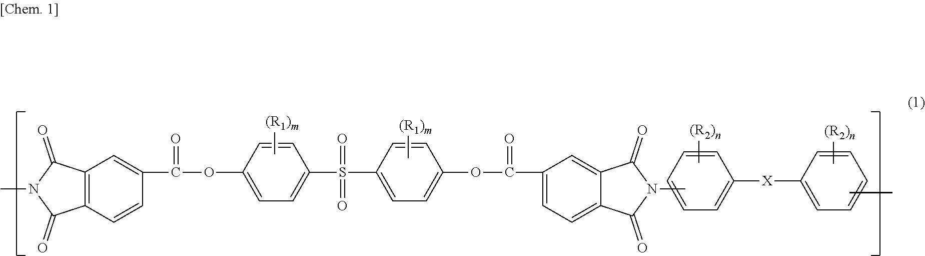

(In the formula, X represents a direct bond or a sulfonyl group (—SO₂—), R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2.)
2. A polyimide having a repeating unit represented by general formula (2) below.

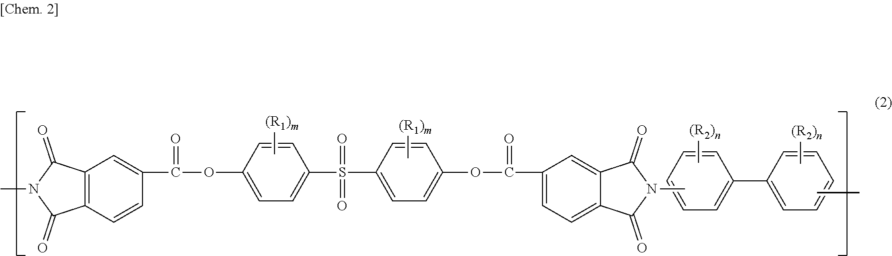

(In the formula, R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2.)
3. A colorless transparent processed product obtained using the polyimide resin material according to 1.

### Advantageous Effects of Invention

The polyimide resin material for a colorless transparent processed product according to the present invention and the novel polyimide according to the present invention, because of having high colorless transparency in addition to high heat resistance characteristic of polyimides, can be used as materials for producing colorless transparent processed products.

Furthermore, the polyimide resin material for a colorless transparent processed product according to the present invention, because of having thermoplasticity, can be molded by known melt molding methods, namely, injection molding, extrusion molding, hollow molding, compression molding, rotational molding, blow molding, calender molding, melt spinning molding, foam molding, fused deposition modeling, selective laser sintering, and the like, and can be subjected to melt processing such as fusion bonding or welding; the polyimide resin material has high processability and thus is useful for producing various colorless transparent processed products.

### BRIEF DESCRIPTION OF DRAWINGS

FIG. 1 is a graph showing a TMA curve of a polyimide obtained in Example 1.

FIG. 2 shows an infrared absorption spectrum of the polyimide obtained in Example 1.

FIG. 3 is a graph showing a TMA curve of a polyimide obtained in Example 2.

### DESCRIPTION OF EMBODIMENTS

A polyimide resin material for a colorless transparent processed product according to the present invention contains a polyimide having a repeating unit represented by general formula (1) below.

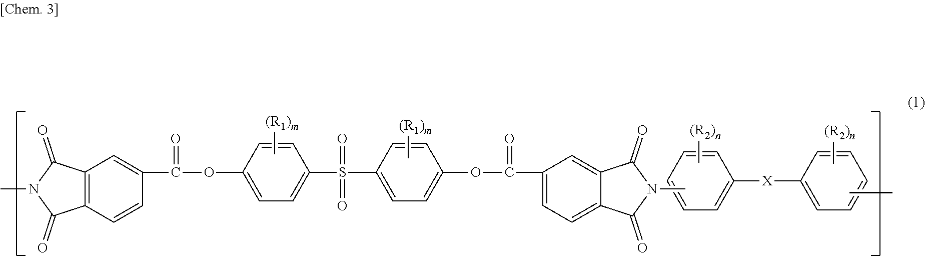

(In the formula, X represents a direct bond or a sulfonyl group (—SO₂—), R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2.)

The present invention also provides a novel polyimide having a repeating unit represented by general formula (2) below.

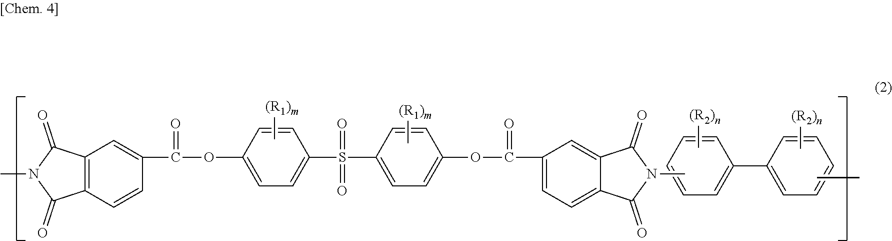

(In the formula, R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2.)

R₁ and R₂ in general formulae (1) and (2) above each independently represent a linear or branched alkyl group having 1 to 6 carbon atoms, a linear or branched alkyl halide group having 1 to 6 carbon atoms, or a halogen atom, preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, particularly preferably a trifluoromethyl group or a fluorine atom.

The position of substitution of each R₁ is preferably the ortho position relative to the oxygen atom, and the position of substitution of each R₂ is preferably the meta position relative to the nitrogen atom.

Each m in general formulae (1) and (2) above independently represents 0, 1, or 2, preferably 0 or 1, particularly preferably 0.

Each n in general formulae (1) and (2) above independently represents 0, 1, or 2, preferably 0 or 1, particularly preferably 1.

The position of bonding of each nitrogen atom to the benzene ring in general formula (1) above is preferably the meta or para position, particularly preferably the para position, relative to X.

The position of bonding of each nitrogen atom to the benzene ring in general formula (2) above is preferably the meta or para position, particularly preferably the para position, relative to the position of the direct bond between the two benzene rings.

“Colorless transparent” in the present invention means that when a colorless transparent processed product produced using the polyimide resin material for a colorless transparent processed product according to the present invention is visually observed, the processed product has only a little tinge (particularly yellow tinge) and has transparency.

For example, Kapton (registered trademark) and UPILEX (registered trademark), which are commercially available polyimides, have transparency but appear to have a significant tinge (particularly yellow tinge) when visually observed. By contrast, a processed product produced using the polyimide resin material for a colorless transparent processed product according to the present invention has transparency and appears to have only a very little tinge.

The transmittance of light decreases as the thickness (optical path length) of an object increases, and thus the colorless transparency of a processed product on visual inspection varies depending on the thickness of the processed product. In view of this, when a film is produced as a specific example of an embodiment of the processed product produced using the polyimide resin material for a colorless transparent processed product according to the present invention, a state in which the total light transmittance determined according to JIS K 7361 is 80% or more and the YI value (yellowness) determined according to ASTM E313-05 is 5.0 or less when the film has a thickness of at least 1 μm is referred to as “colorless transparent” in the present invention. A state in which the total light transmittance determined according to JIS K 7361 is 80% or more and the YI value (yellowness) determined according to ASTM E313-05 is 5.0 or less when the film has a thickness of 10 μm is preferred. A state in which the total light transmittance determined according to JIS K 7361 is 80% or more and the YI value (yellowness) determined according to ASTM E313-05 is 5.0 or less when the film has a thickness of 25 μm is more preferred. A state in which the total light transmittance determined according to JIS K 7361 is 80% or more and the YI value (yellowness) determined according to ASTM E313-05 is 5.0 or less when the film has a thickness of 50 μm is still more preferred. A state in which the total light transmittance determined according to JIS K 7361 is 80% or more and the YI value (yellowness) determined according to ASTM E313-05 is 5.0 or less when the film has a thickness of 125 μm is particularly preferred.

Furthermore, when a film is produced using the polyimide resin material for a colorless transparent processed product according to the present invention, it is preferred that the haze value determined according to JIS K 7136 is 2 or less or the light transmittance at a wavelength of 400 nm is 70% or more when the film has a thickness of at least 1 μm, and, furthermore, it is preferred that the haze value determined according to JIS K 7136 is 2 or less and the light transmittance at a wavelength of 400 nm is 70% or more when the film has a thickness of at least 1 μm. It is preferred that the haze value determined according to JIS K 7136 is 2 or less or the light transmittance at a wavelength of 400 nm is 70% or more when the film has a thickness of 10 μm, and, furthermore, it is preferred that the haze value determined according to JIS K 7136 is 2 or less and the light transmittance at a wavelength of 400 nm is 70% or more when the film has a thickness of 10 μm. It is preferred that the haze value determined according to JIS K 7136 is 2 or less or the light transmittance at a wavelength of 400 nm is 70% or more when the film has a thickness of 25 μm, and, furthermore, it is more preferred that the haze value determined according to JIS K 7136 is 2 or less and the light transmittance at a wavelength of 400 nm is 70% or more when the film has a thickness of 25 μm. It is preferred that the haze value determined according to JIS K 7136 is 2 or less or the light transmittance at a wavelength of 400 nm is 70% or more when the film has a thickness of 50 μm, and, furthermore, it is still more preferred that the haze value determined according to JIS K 7136 is 2 or less and the light transmittance at a wavelength of 400 nm is 70% or more when the film has a thickness of 50 μm. It is preferred that the haze value determined according to JIS K 7136 is 2 or less or the light transmittance at a wavelength of 400 nm is 70% or more when the film has a thickness of 125 μm, and, furthermore, it is particularly preferred that the haze value determined according to JIS K 7136 is 2 or less and the light transmittance at a wavelength of 400 nm is 70% or more when the film has a thickness of 125 μm.

Colorless transparent processed products in the present invention include a processed product obtained as a film using the above-described polyimide resin material that is colorless transparent.

The method for producing the polyimide contained in the polyimide resin material for a colorless transparent processed product according to the present invention is not particularly limited, and a known method can be appropriately applied. For example, the polyimide can be produced through a step of reacting a tetracarboxylic dianhydride represented by general formula (3) below and a diamine compound represented by general formula (4) below such that the amounts of the substances are equimolar to obtain a polyimide precursor (polyamic acid) and a step of imidizing the polyimide precursor.

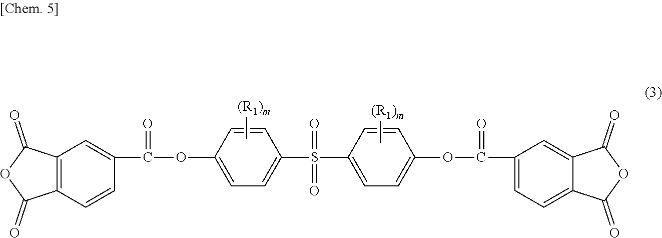

(In the formula, R₁ and m are the same as those in general formula (1).)

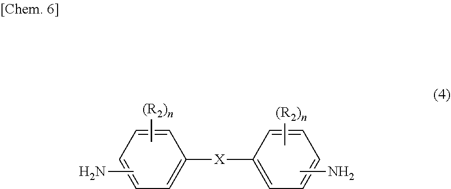

(In the formula, R₂, X, and n are the same as those in general formula (1).)

The novel polyimide having a repeating unit represented by general formula (2) according to the present invention is one embodiment of the polyimide contained in the polyimide resin material for a colorless transparent processed product. The method for producing the novel polyimide is not particularly limited, and a known method can be appropriately applied. For example, the novel polyimide can be produced through a step of reacting a tetracarboxylic dianhydride represented by general formula (3) above and a diamine compound represented by general formula (4) above where X is a direct bond such that the amounts of the substances are equimolar to obtain a polyimide precursor (polyamic acid) and a step of imidizing the polyimide precursor.

As a specific example of the method, a production method in the case where the tetracarboxylic dianhydride represented by general formula (3) above is 4,4′-dihydroxydiphenylsulfone-bis(trimellitate anhydride) (a) and the diamine compound represented by general formula (4) above is 2,2′-bis(trifluoromethyl)benzidine (b) is shown by the following reaction formula. The compound (a) and the compound (b) are polymerized to obtain a polyimide precursor (polyamic acid) (c) having the following repeating unit, and the polyimide precursor (c) is imidized, whereby a target polyimide (d) having the following repeating unit can be obtained.

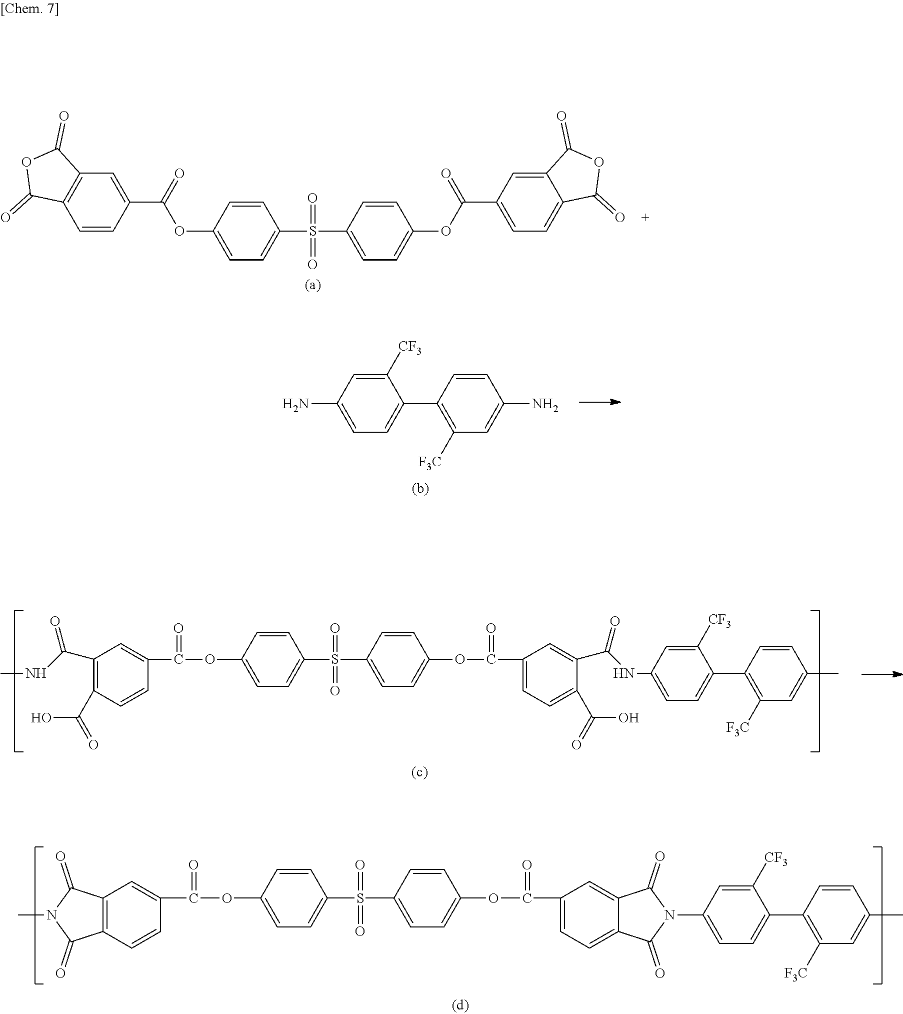

For the tetracarboxylic dianhydride represented by general formula (3) above, R₁ and m are the same as those in general formula (1), and preferred modes thereof are also the same.

Specific examples of the tetracarboxylic dianhydride represented by general formula (3) include 4,4′-dihydroxydiphenylsulfone-bis(trimellitate anhydride), 4,4′-dihydroxy-3,3′-dimethyldiphenylsulfone-bis (trimellitate anhydride), 4,4′-dihydroxy-3,3′,5,5′-tetramethyldiphenylsulfone-bis(trimellitate anhydride), 4,4′-dihydroxy-3,3′-bis(trifluoromethyl)diphenylsulfone-bis(trimellitate anhydride), 4,4′-dihydroxy-3,3′,5,5′-tetrakis(trifluoromethyl)diphenylsulfone-bis(trimellitate anhydride), 4,4′-dihydroxy-3,3′-difluorodiphenylsulfone-bis(trimellitate anhydride), 4,4′-dihydroxy-3,3′,5,5′-tetrafluorodiphenylsulfone-bis(trimellitate anhydride), 4,4′-dihydroxy-3,3′-dichlorodiphenylsulfone-bis(trimellitate anhydride), 4,4′-dihydroxy-3,3′,5,5′-tetrachlorodiphenylsulfone-bis(trimellitate anhydride), 4,4′-dihydroxy-3,3′-dibromodiphenylsulfone-bis(trimellitate anhydride), and 4,4′-dihydroxy-3,3′,5,5′-tetrabromodiphenylsulfone-bis (trimellitate anhydride).

Of these, 4,4′-dihydroxydiphenylsulfone-bis(trimellitate anhydride), 4,4′-dihydroxy-3,3′-dimethyldiphenylsulfone-bis(trimellitate anhydride), 4,4′-dihydroxy-3,3′,5,5′-tetramethyldiphenylsulfone-bis(trimellitate anhydride), 4,4′-dihydroxy-3,3′-bis(trifluoromethyl)diphenylsulfone-bis(trimellitate anhydride), and 4,4′-dihydroxy-3,3′,5,5′-tetrakis(trifluoromethyl)diphenylsulfone-bis(trimellitate anhydride) are preferred, and 4,4′-dihydroxydiphenylsulfone-bis(trimellitate anhydride) is particularly preferred.

For the diamine compound represented by general formula (4), R₂, X, and n are the same as those in general formula (1), and preferred modes thereof are also the same. Specific examples of the diamine compound represented by general formula (4) include 2,2′-dimethylbenzidine, 3,3′-dimethylbenzidine, 3,3′,5,5′-tetramethylbenzidine, 2,2′,6,6′-tetramethylbenzidine, 2,2′-bis(trifluoromethyl)benzidine, 3,3′-bis(trifluoromethyl)benzidine, 2,2′-difluorobenzidine, 3,3′-difluorobenzidine, 3,3′,5,5′-tetrafluorobenzidine, 2,2′-dichlorobenzidine, 3,3′-dichlorobenzidine, 3,3′,5,5′-tetrachlorobenzidine, 2,2′-dibromobenzidine, 3,3′-dibromobenzidine, 3,3′,5,5′-tetrabromobenzidine, 2,2′-diamino-5,5′-dimethylbiphenyl, 2,2′-diamino-6,6′-dimethylbiphenyl, 3,3′-diamino-6,6′-dimethylbiphenyl, 3,3′-diamino-5,5′-dimethylbiphenyl, 4,4′-diaminodiphenylsulfone, 4,4′-diamino-3,3′-dimethyldiphenylsulfone, 4,4′-diamino-3,3′,5,5′-tetramethyldiphenylsulfone, 4,4′-diamino-3,3′-bis(trifluoromethyl)diphenylsulfone, 4,4′-diamino-3,3′,5,5′-tetrakis(trifluoromethyl)diphenylsulfone, 4,4′-diamino-3,3′-difluorodiphenylsulfone, 4,4′-diamino-3,3′,5,5′-tetrafluorodiphenylsulfone, 4,4′-diamino-3,3′-dichlorodiphenylsulfone, 4,4′-diamino-3,3′,5,5′-tetrachlorodiphenylsulfone, 4,4′-diamino-3,3′-dibromodiphenylsulfone, 4,4′-diamino-3,3′,5,5′-tetrabromodiphenylsulfone, 3,3′-diaminodiphenylsulfone, 3,3′-diamino-5,5′-dimethyldiphenylsulfone, 3,3′-diamino-5,5′-bis(trifluoromethyl)diphenylsulfone, 3,3′-diamino-5,5′-difluorodiphenylsulfone, 3,3′-diamino-5,5′-dichlorodiphenylsulfone, and 3,3′-diamino-5,5′-dibromodiphenylsulfone.

Of these, 2,2′-dimethylbenzidine, 3,3′-dimethylbenzidine, 3,3′,5,5′-tetramethylbenzidine, 2,2′,6,6′-tetramethylbenzidine, 2,2′-bis(trifluoromethyl)benzidine, 3,3′-bis(trifluoromethyl)benzidine, 2,2′-difluorobenzidine, 2,2′-dichlorobenzidine, 4,4′-diaminodiphenylsulfone, and 3,3′-diaminodiphenylsulfone are preferred, and 2,2′-bis(trifluoromethyl)benzidine and 4,4′-diaminodiphenylsulfone are particularly preferred.

The polyimide contained in the polyimide resin material for a colorless transparent processed product according to the present invention, if containing the repeating unit represented by general formula (1) above, may have another skeleton without impairing the advantageous effects of the present invention. For example, a tetracarboxylic dianhydride and a diamine that form a skeleton other than the skeleton represented by general formula (1) above can be used. In this case, the repeating unit of the polyimide according to the present invention represented by general formula (1) above is contained in an amount of preferably 50 mol % or more, more preferably 60 mol % or more, still more preferably 70 mol % or more, particularly preferably 90 mol % or more, relative to the total amount of the polyimide. The repeating unit of general formula (1) above may be regularly arranged or randomly present in the polyimide.

The polyimide according to the present invention represented by general formula (2) above, if containing the repeating unit represented by general formula (2) above, may have another skeleton without impairing the advantageous effects of the present invention. For example, a tetracarboxylic dianhydride and a diamine that form a skeleton other than the skeleton represented by general formula (2) above can be used. In this case, the repeating unit of the polyimide according to the present invention represented by general formula (2) above is contained in an amount of 50 mol % or more, preferably 60 mol % or more, still more preferably 70 mol % or more, most preferably 90 mol % or more, relative to the total amount of the polyimide. The repeating unit of general formula (2) above may be regularly arranged or randomly present in the polyimide.

When the polyimide contained in the polyimide resin material for a colorless transparent processed product according to the present invention and the novel polyimide having a repeating unit represented by general formula (2) according to the present invention are produced through the above-described steps, specifically, for example, they can be synthesized by the following method.

First, a diamine compound is dissolved in a polymerization solvent, and powder of a tetracarboxylic dianhydride substantially equimolar to the diamine compound is slowly added to the solution. Using a mechanical stirrer or the like, the resulting solution is stirred at a temperature in the range of 0° C. to 100° C., preferably in the range of 20° C. to 60° C., for 0.5 to 150 hours, preferably 1 to 72 hours. At this time, the monomer concentration is typically in the range of 5 to 50 wt %, preferably in the range of 10 to 40 wt %. By performing polymerization in such a monomer concentration range, a uniform and highly polymerized polyimide precursor (polyamic acid) can be obtained. If the degree of polymerization of the polyimide precursor (polyamic acid) is excessively increased to make it difficult to stir the polymer solution, the polymer solution may be appropriately diluted with the same solvent. By performing polymerization in the above monomer concentration range, the degree of polymerization of the polymer can be sufficiently high, and the solubility of the monomers and the polymer can be sufficiently secured. If the polymerization is performed at a concentration lower than the above range, the degree of polymerization of the polyimide precursor (polyamic acid) may not be sufficiently high, and if the polymerization is performed at a concentration higher than the above monomer concentration range, the dissolution of the monomers and the resulting polymer may be insufficient.

The solvent used for the polymerization of the polyimide precursor (polyamic acid) is preferably an aprotic solvent such as N,N-dimethylformamide, N,N-dimethylacetamide, N-methyl-2-pyrrolidone, or dimethylsulfoxide, but any solvent in which the starting monomers, the resulting polyimide precursor (polyamic acid), and an imidized polyimide are soluble can be used without any problem, and the structure and type of the solvent are not particularly limited. Specific examples include amide solvents such as N,N-dimethylformamide, N,N-dimethylacetamide, and N-methyl-2-pyrrolidone; ester solvents such as γ-butyrolactone, γ-valerolactone, 5-valerolactone, γ-caprolactone, ε-caprolactone, α-methyl-γ-butyrolactone, butyl acetate, ethyl acetate, and isobutyl acetate; carbonate solvents such as ethylene carbonate and propylene carbonate; glycol solvents such as diethylene glycol dimethyl ether, triethylene glycol, and triethylene glycol dimethyl ether; phenolic solvents such as phenol, m-cresol, p-cresol, o-cresol, 3-chlorophenol, and 4-chlorophenol; ketone solvents such as cyclopentanone, cyclohexanone, acetone, methyl ethyl ketone, diisobutyl ketone, and methyl isobutyl ketone; and ether solvents such as tetrahydrofuran, 1,4-dioxane, dimethoxyethane, diethoxyethane, and dibutyl ether. Other general-purpose solvents that can be used include acetophenone, 1,3-dimethyl-2-imidazolidinone, sulfolane, dimethylsulfoxide, propylene glycol methyl acetate, ethyl cellosolve, butyl cellosolve, 2-methyl cellosolve acetate, ethyl cellosolve acetate, butyl cellosolve acetate, butanol, ethanol, xylene, toluene, chlorobenzene, turpentine, mineral spirits, and petroleum naphtha solvents. These solvents may be used as a mixture of two or more.

A method for imidizing the polyimide precursor (polyamic acid) obtained will be described.

For imidization, a known imidization method can be applied. For example, a “thermal imidization method” in which a polyimide precursor (polyamic acid) film is thermally cyclized, a “solution thermal imidization method” in which a polyimide precursor (polyamic acid) solution is cyclized at a high temperature, a “chemical imidization method” in which a dehydrator is used, or the like can be appropriately used.

Specifically, in the “thermal imidization method”, the polyimide precursor (polyamic acid) solution is cast on a substrate or the like and dried at 50° C. to 200° C., preferably 60° C. to 150° C., to form a polyimide precursor (polyamic acid) film, which is then heated in an inert gas or under reduced pressure at 150° C. to 400° C., preferably 200° C. to 380° C., for 1 to 12 hours to cause thermal dehydration cyclization and complete imidization, whereby the polyimide contained in the polyimide resin material for a colorless transparent processed product according to the present invention can be obtained. Also, in this manner, the polyimide resin material for a colorless transparent processed product according to the present invention in the form of a film can be obtained.

In the “solution thermal imidization method”, the polyimide precursor (polyamic acid) solution to which a basic catalyst or the like has been added is heated in the presence of an azeotropic agent such as xylene at 100° C. to 250° C., preferably 150° C. to 220° C., for 0.5 to 12 hours to remove water produced as a by-product out of the system and complete imidization, whereby a solution of the polyimide contained in the polyimide resin material for a colorless transparent processed product according to the present invention can be obtained.

In the “chemical imidization method”, while the polyimide precursor (polyamic acid) solution adjusted to have an appropriate solution viscosity that allows the polyimide precursor (polyamic acid) to be easily stirred is stirred with a mechanical stirrer or the like, a dehydration cyclizing agent (chemical imidizing agent) composed of an organic acid anhydride and an amine as a basic catalyst is added dropwise, and stirring is performed at 0° C. to 100° C., preferably 10° C. to 50° C., for 1 to 72 hours to chemically complete imidization. Examples of the organic acid anhydride usable here include, but are not limited to, acetic anhydride and propionic anhydride. In terms of the ease of handling and purification of a reagent, acetic anhydride is suitable for use. As the basic catalyst, pyridine, triethylamine, quinoline, or the like can be used, and in terms of the ease of handling and separation of a reagent, pyridine is suitable for use, but the basic catalyst is not limited thereto. The amount of the organic acid anhydride in the chemical imidizing agent is in the range of 1 to 10 times, more preferably in the range of 1 to 5 times, the theoretical dehydration amount of the polyimide precursor (polyamic acid) on a molar basis. The amount of the basic catalyst is in the range of 0.1 to 2 times, more preferably in the range of 0.1 to 1 times, the amount of the organic acid anhydride on a molar basis.

In the “solution thermal imidization method” or the “chemical imidization method”, the reaction solution contains the catalyst, the chemical imidizing agent, and by-products such as carboxylic acids (hereinafter referred to as impurities) and thus may be purified by removal thereof. For the purification, a known method can be used. For example, one of the most convenient methods is a method in which the reaction solution subjected to imidization is added dropwise into a large amount of poor solvent with stirring to precipitate the polyimide, and then the polyimide powder is recovered and repeatedly washed until the impurities are removed. Solvents suitable for use here are water and alcohols such as methanol, ethanol, and isopropanol, which cause the polyimide to precipitate, allow the impurities to be efficiently removed, and are readily dried, and these may be used as a mixture. If the concentration of the polyimide solution added dropwise into the poor solvent to cause precipitation is excessively high, the polyimide precipitated becomes a granular mass, so that the impurities may remain in the coarse particles, or it may take a long time to dissolve the obtained polyimide powder in the solvent. On the other hand, if the concentration of the polyimide solution is excessively low, a great amount of poor solvent is required, which is not preferred because disposal of waste solvent leads to an increased environmental load and a higher production cost. Therefore, the concentration of the polyimide solution added dropwise into the poor solvent is 20 wt % or less, more preferably 10 wt % or less. The amount of the poor solvent used here is preferably equal to or more than, suitably 1.5 to 3 times, the amount of the polyimide solution.

The polyimide powder obtained is recovered, and residual solvent is removed by, for example, vacuum drying or hot-air drying, whereby the polyimide contained in the polyimide resin material for a colorless transparent processed product according to the present invention can be obtained. Also, in this manner, the polyimide resin material for a colorless transparent processed product according to the present invention in the form of powder can be obtained. The temperature and time of drying are not limited as long as the polyimide does not degrade or the residual solvent does not decompose at the temperature, and drying in a temperature range of 30° C. to 200° C. for 48 hours or less is preferred.

The intrinsic viscosity of the polyimide contained in the polyimide resin material for a colorless transparent processed product according to the present invention is preferably in the range of 0.1 to 10.0 dL/g, more preferably in the range of 0.2 to 5.0 dL/g.

The polyimide contained in the polyimide resin material for a colorless transparent processed product according to the present invention and the polyimide resin material for a colorless transparent processed product according to the present invention are soluble in various organic solvents and thus can be formed into polyimide varnish.

As an organic solvent therefor, an appropriate solvent can be selected according to the intended use and processing conditions of the varnish. Examples of solvents that can be used include, but are not limited to, amide solvents such as N,N-dimethylformamide, N,N-dimethylacetamide, and N-methyl-2-pyrrolidone; ester solvents such as γ-butyrolactone, γ-valerolactone, δ-valerolactone, γ-caprolactone, s-caprolactone, and α-methyl-γ-butyrolactone; carbonate solvents such as ethylene carbonate and propylene carbonate; glycol solvents such as diethylene glycol dimethyl ether, triethylene glycol, and triethylene glycol dimethyl ether; phenolic solvents such as phenol, m-cresol, p-cresol, o-cresol, 3-chlorophenol, and 4-chlorophenol; ketone solvents such as cyclopentanone, cyclohexanone, acetone, methyl ethyl ketone, diisobutyl ketone, and methyl isobutyl ketone; ether solvents such as tetrahydrofuran, 1,4-dioxane, dimethoxyethane, diethoxyethane, and dibutyl ether; and other general-purpose solvents such as acetophenone, 1,3-dimethyl-2-imidazolidinone, sulfolane, dimethylsulfoxide, butyl acetate, ethyl acetate, isobutyl acetate, propylene glycol methyl acetate, ethyl cellosolve, putyl cellosolve, 2-methyl cellosolve acetate, ethyl cellosolve acetate, putyl cellosolve acetate, chloroform, butanol, ethanol, xylene, toluene, chlorobenzene, turpentine, mineral spirits, and petroleum naphtha solvents. Of these, from the viewpoint of solubility, amide solvents such as N,N-dimethylformamide, N,N-dimethylacetamide, N-methyl-2-pyrrolidone; ester solvents such as γ-butyrolactone, γ-valerolactone, δ-valerolactone, γ-caprolactone, ε-caprolactone, and α-methyl-γ-butyrolactone; and carbonate solvents such as ethylene carbonate and propylene carbonate are preferably used. These solvents may be used as a mixture of two or more.

When the polyimide contained in the polyimide resin material for a colorless transparent processed product according to the present invention or the polyimide resin material for a colorless transparent processed product according to the present invention is dissolved in a solvent to form into varnish, the solids concentration can be appropriately selected according to the intended use of the varnish and is not particularly limited. For example, when the varnish is formed into a film, although depending on the molecular weight of the polyimide, the production method, and the thickness of the film to be produced, the solids concentration is preferably 5 wt % or more. An excessively low solids concentration may result in difficulty in forming a film with a sufficient thickness, whereas a high solids concentration may result in difficulty in performing coating because of an excessively high solution viscosity. The method of dissolving the polyimide contained in the polyimide resin material for a colorless transparent processed product according to the present invention in a solvent is, for example, as follows: while the solvent is stirred, the polyimide powder is added and dissolved in air or an inert gas in a temperature range from room temperature to the boiling point of the solvent over 1 hour to 48 hours, whereby a polyimide solution can be formed.

In the present invention, additives such as release agents, fillers, silane coupling agents, crosslinking agents, end-capping agents, antioxidants, antifoaming agents, and leveling agents can be added to the polyimide varnish as needed.

The varnish obtained can be used to produce, for example, a film-like or tape-like polyimide resin material for a colorless transparent processed product. The varnish can also be used to produce a colorless transparent processed product such as a polyimide film or a laminate. For their production method, for example, the polyimide film can be formed by casting the polyimide varnish on a support such as a glass substrate using a doctor blade or the like and drying the polyimide varnish using a hot-air dryer, an infrared drying furnace, a vacuum dryer, an inert oven, or the like typically in the range of 40° C. to 300° C., preferably in the range of 50° C. to 250° C.

The shape of the polyimide resin material for a colorless transparent processed product according to the present invention is not particularly limited as long as it is suitable for producing a colorless transparent processed product containing the polyimide according to the present invention, and may be, for example, powder-like, particle-like, chip-like, fiber-like, pellet-like, film-like, or tape-like.

In one embodiment, the polyimide resin material for a colorless transparent processed product according to the present invention may contain only the polyimide having a repeating unit represented by general formula (1) above without containing other components. In another embodiment, the polyimide resin material for a colorless transparent processed product according to the present invention may contain other optional components (e.g., other known thermoplastic resin materials, additives, colorants, and fillers) for various purposes. For example, the polyimide resin material may contain high-density polyethylene, medium-density polyethylene, isotactic polypropylene, polycarbonate, polyarylate, aliphatic polyamide, aromatic polyamide, polyamide-imide, polysulfone, polyethersulfone, polyether ketone, polyphenylene sulfide, polyether imide, polyester imide, modified polyphenylene oxide, hydrophilic agents, antioxidants, secondary antioxidants, lubricants, release agents, antifogging agents, weathering stabilizers, light stabilizers, UV absorbers, antistatic agents, metal deactivators, dyes, pigments, various powder metals, silver nanowires, carbon fibers, glass fibers, carbon nanotubes, graphene, ceramic materials such as calcium carbonate, titanium oxide, and silica, and the like. These can be incorporated in appropriate amounts depending on the intended use.

The polyimide resin material for a colorless transparent processed product according to the present invention, because of having thermoplasticity, can be processed by commonly known melt molding methods, namely, not only injection molding, extrusion molding, hollow molding, compression molding, rotational molding, blow molding, calender molding, melt spinning molding, foam molding, and the like, but also fused deposition modeling, selective laser sintering, and the like, and can be subjected to melt processing such as fusion bonding or welding to, for example, a different resin material or a metal material.

Examples of colorless transparent processed products obtained using the polyimide resin material for a colorless transparent processed product according to the present invention include films, sheets, tapes, containers, threads, lenses, tubes, other molded products, and solutions. In particular, the polyimide resin material is suitable for films, sheets, tapes, and lenses. More specific examples of colorless transparent processed products include transparent substrates, cover films, optical films (e.g., light guide plates, polarizing plates, polarizing plate protective films, retardation films, light diffusion films, wide view films, reflective films, antireflective films, antiglare films, brightness enhancement films, prism sheets, and light guide films), adhesive films, adhesive sheets, and 3D printed objects for devices for display units, such as liquid crystal displays, plasma displays, organic EL displays, flexible displays, foldable displays, and rollable displays, touch panels, organic EL illuminators, solar cells, and the like; lenses for optical devices, such as cameras, video cameras, video playback devices, and projectors, and LEDs; optical lenses such as Fresnel lenses and prisms; substrates and protective films for various optical discs (e.g., VD, CD, DVD, MD, and LD); optical products such as optical fibers, optical switches, optical connectors, and optical waveguides; transportation equipment members for automobiles, trains, ships, airplanes, and the like, such as tail lamp lenses, headlamp lenses, inner lenses, amber caps, reflectors, extensions, side mirrors, rearview mirrors, side visors, meter needles, meter covers, glazings typified by window glass, camera lenses, sensor lenses, and displays; and home appliances, OA components, sundries, dining utensils, storage containers for foods and cosmetics, toys, threads, ropes, wires, interior decorations, accessories, packaging sheets for tablets (PTP), prefilled syringes, tablet bottles, cosmetic containers, food containers, drug containers, chemical containers, containers for inspection, optical cells for analysis, shrinkable tubes, shrinkable films, easily tearable films for food packaging, containers for electronic component transportation, eyeglass lenses, eyeglass frames, contact lenses, endoscopes, coating agents for metals, plastics, rubber, paper, woods, and ceramics, paints, inks, resists, protective coating agents for semiconductors, heat-resistant insulating tapes, wire enamel, liquid crystal alignment films, flexible gas barrier films, printer transfer belts, lighting windows, roadway light-transmitting panels, lighting covers, signboards, light-transmitting noise barriers, and building members such as bathtubs.

Of these, transparent substrates, cover films, optical films (e.g., light guide plates, polarizing plates, polarizing plate protective films, retardation films, light diffusion films, wide view films, reflective films, antireflective films, antiglare films, brightness enhancement films, prism sheets, and light guide films), and 3D printed objects for devices for display units, such as liquid crystal displays, plasma displays, and organic EL displays, touch panels, organic EL illuminators, solar cells, and the like are suitable.

### EXAMPLES

The present invention will now be described more specifically with reference to Examples, but it should be noted that the present invention is not limited to these Examples.

Analysis methods in the present invention are as follows.

### Analysis Methods

### (1) Intrinsic Viscosity

A 0.5 wt % polyimide precursor solution was prepared, and a reduced viscosity at 40° C. was measured using an Ostwald viscometer. This value was regarded as an intrinsic viscosity.

### (2) Glass Transition Temperature (Tg) and Thermoplasticity

A polyimide film obtained was measured using the following apparatus under the following conditions, and a glass transition temperature (Tg) was calculated as an extrapolated point from a TMA curve. Thermoplasticity was evaluated from the steepness of a displacement of the TMA curve.

Apparatus: TMA7100 manufactured by Hitachi High-Tech Science Corporation
Sample size: width, 5 mm; length, 15 mm
Conditions: load, 20 mN; temperature range, 30° C. to 350° C.; heating rate, 5° C./min
Measurement mode: tensile

### (3) Total Light Transmittance, Haze Value (Cloudiness), YI Value (Yellowness)

A polyimide film obtained was measured for total light transmittance, haze value (cloudiness), and YI value (yellowness) using the following apparatus by methods in accordance with JIS K 7361, JIS K 7136, and ASTM E313-05, respectively. The measurements were each performed three times, and the average values were employed as measured values.

Apparatus: spectral color and haze meter COH7700 manufactured by Nippon Denshoku Industries Co., Ltd.

### (4) Light Transmittance (400 nm)

The light transmittances at wavelengths of 400 to 700 nm of a polyimide film obtained were measured using the same apparatus as in (3) above to determine the light transmittance at a wavelength of 400 nm.

### (5) Infrared Spectrophotometry

A polyimide film obtained was measured using the following apparatus under the following conditions and determined whether it was the target from the infrared absorption spectrum obtained.
Apparatus: IRPrestige-21 manufactured by Shimadzu Corporation
Conditions: measured wavenumber range, 4000 to 750 cm-1; the number of scans, 40
Measurement method: ATR method

### <Example 1>: Method for Producing Polyimide (d) Having Following Repeating Unit

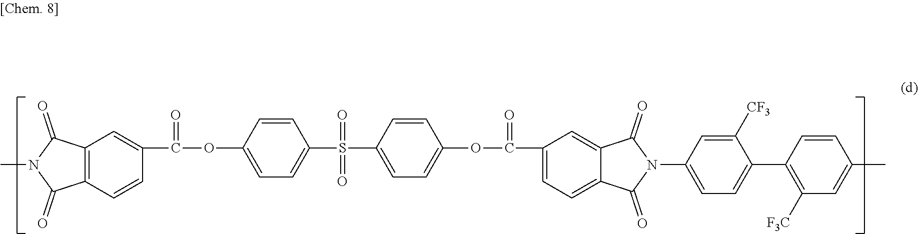

In a 100 mL screw vial, 2.5621 g of 2,2′-bis(trifluoromethyl)benzidine (b) and 66.1595 g of dimethylacetamide (DMAc) were added and allowed to dissolve. Subsequently, 4.7897 g of 4,4′-dihydroxydiphenylsulfone-bis(trimellitate anhydride) (a) was added to the completely dissolved diamine solution. The resulting solution was stirred in a nitrogen atmosphere, and the stirring was stopped when the viscosity of the solution became sufficiently high, whereby a polyamic acid solution (c) having a resin content of 10 wt % and an intrinsic viscosity of 2.25 dl/g (0.5 wt %, 40° C.) was obtained.

The polyamic acid (c) was cast on a flat glass plate serving as a support, and after the solvent was removed at 60° C. under a stream of nitrogen over 2 hours, the temperature was raised stepwise to 320° C. to perform imidization. The film subjected to imidization was immersed in water, peeled off, and then dried at 250° C. and 0.1 kPa for 1 hour. The polyimide film obtained was a colorless transparent film having a thickness of 11 μm. Measured values of the total light transmittance, the haze value, the YI value, and the light transmittance at a wavelength of 400 nm of the polyimide film obtained are listed in Table 1 below.

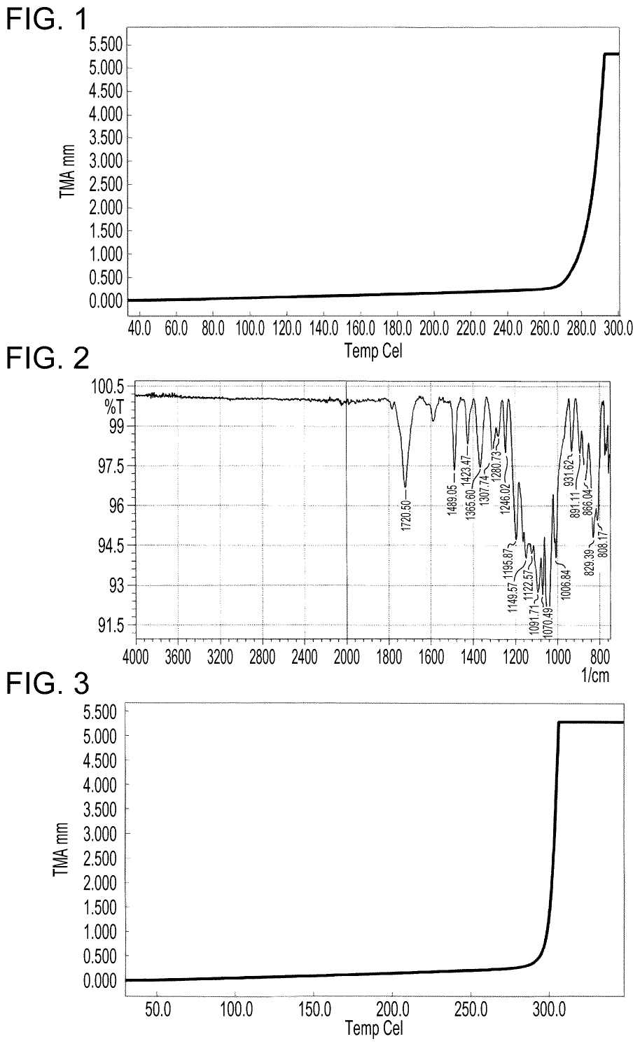

In a TMA measurement, softening occurred at a glass transition temperature of 284° C., and a steep displacement was observed, thus confirming that the polyimide film was a thermoplastic resin. The TMA curve of the polyimide obtained is shown in FIG. 1.

Furthermore, the infrared absorption spectrum of the polyimide film obtained is shown in FIG. 2. The infrared absorption spectrum shown in FIG. 2 has confirmed that the target polyimide was obtained, because there is no absorption near 3300 cm-1 corresponding to N—H stretching vibration of amide groups in the polyimide precursor (polyamic acid), and characteristic absorption corresponding to C═O stretching vibration of imide groups in the polyimide can be observed near 1720 cm-1.

### <Example 2>: Method for Producing Polyimide Having Following Repeating Unit

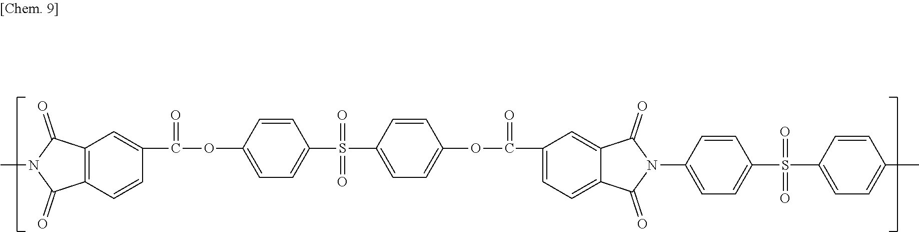

In a 100 mL screw vial, 1.9862 g of 4,4′-diaminodiphenylsulfone and 27.0957 g of dimethylacetamide (DMAc) were added and allowed to dissolve at room temperature. Subsequently, 4.7885 g of 4,4′-dihydroxydiphenylsulfone-bis(trimellitate anhydride) was added to the completely dissolved diamine solution. The resulting solution was stirred in a nitrogen atmosphere, and the stirring was stopped when the viscosity of the solution became sufficiently high, whereby a polyamic acid solution having a resin content of 20 wt % and a reduced viscosity of 0.484 dl/g (0.5 wt %, 40° C.) was obtained.

The polyamic acid was cast on a flat glass plate serving as a support, and after the solvent was removed at 60° C. under a stream of nitrogen over 2 hours, the temperature was raised stepwise to 320° C. to perform imidization.

The film subjected to imidization was immersed in water, peeled off, and then dried at 250° C. and 0.1 kPa for 1 hour. The polyimide film obtained was a colorless transparent film having a thickness of 18 μm. Measured values of the total light transmittance, the haze value, the YI value, and the light transmittance at a wavelength of 400 nm of the polyimide film obtained are listed in Table 1 below.

In a TMA measurement, softening occurred at a glass transition temperature of 298° C., and a steep displacement was observed, thus confirming that the polyimide film was a thermoplastic resin. The TMA curve of the polyimide film obtained is shown in FIG. 3.

### Comparative Example 1

In a 100 mL screw vial, 1.6016 g of 4,4′-diaminodiphenyl ether and 57.5090 g of dimethylacetamide (DMAc) were added and allowed to dissolve at room temperature. Subsequently, 4.7883 g of 4,4′-dihydroxydiphenylsulfone-bis(trimellitate anhydride) was added to the completely dissolved diamine solution. The resulting solution was stirred in a nitrogen atmosphere, and the stirring was stopped when the viscosity of the solution became sufficiently high, whereby a polyamic acid solution having a resin content of 10 wt % and a reduced viscosity of 2.51 dl/g (0.5 wt %, 40° C.) was obtained.

The polyamic acid obtained was cast on a flat glass plate serving as a support, and after the solvent was removed at 60° C. under a stream of nitrogen over 2 hours, the temperature was raised stepwise to 320° C. to perform imidization.

The film subjected to imidization was immersed in water, peeled off, and then dried at 250° C. and 0.1 kPa for 1 hour.

The polyimide film obtained was not colorless and transparent but colored in yellow.

Measured values of the total light transmittance, the haze value, the YI value, and the light transmittance at a wavelength of 400 nm of the polyimide film obtained are listed in Table 1 below.

### Comparative Example 2

A polyimide film was obtained in the same manner as in Comparative Example 1 above except that 4,4′-diaminodiphenyl ether was replaced with a mixture of 0.2161 g of 1,3-diaminobenzene and 0.2167 g of 1,4-diaminobenzene.

### Comparative Example 3

A polyimide film was obtained in the same manner as in Comparative Example 1 above except that 4,4′-diaminodiphenyl ether was replaced with 0.8654 g of 1,3-diaminobenzene.

### Comparative Example 4

A polyimide film was obtained in the same manner as in Comparative Example 1 above except that 4,4′-diaminodiphenyl ether was replaced with 1.6420 g of 2,2-bis[4-(4-aminophenoxy)phenyl]propane.

### Comparative Example 5

A polyimide film was obtained in the same manner as in Comparative Example 1 above except that 4,4′-diaminodiphenyl ether was replaced with 3.4602 g of bis[4-(4-aminophenoxy)phenyl]sulfone.

### Comparative Example 6

A polyimide film was obtained in the same manner as in Comparative Example 1 above except that 4,4′-diaminodiphenyl ether was replaced with 2.3387 g of 1,3-bis(4-aminophenoxy)benzene.

### Comparative Example 7

A polyimide film was obtained in the same manner as in Comparative Example 1 above except that 4,4′-diaminodiphenyl ether was replaced with 1.4739 g of 4,4′-bis(4-aminophenoxy)biphenyl.

### Comparative Example 8

A polyimide film was obtained in the same manner as in Comparative Example 1 above except that 4,4′-diaminodiphenyl ether was replaced with 0.9090 g of 4,4′-diaminobenzanilide.

Measured values of the total light transmittance, the haze value, the YI value, and the light transmittance at a wavelength of 400 nm of the polyimide films of Comparative Examples 2 to 8 are listed in Table 1 below.

### Reference Examples 1 and 2

Measured values of the total light transmittance, the haze value, the YI value, and the light transmittance at a wavelength of 400 nm of a commercially available Kapton (registered trademark) as Reference Example 1 and a commercially available UPILEX (registered trademark)-S as Reference Example 2 are listed in Table 1 below.

TABLE 1

| | | | Total light | | Light | Haze |
|---|---|---|---|---|---|---|
| | | Thickness | transmittance | YI | transmittance | value |
| | | (μm) | (%) | value | (%) | (%) |
| Example | 1 | 11 | 88.9 | 2.5 | 80.2 | 0.7 |
| | 2 | 18 | 87.6 | 3.8 | 74.0 | 0.9 |
| Reference | 1 | 25 | 58.0 | 116.6 | 0 | 6.8 |
| Example | 2 | 30 | 48.4 | 76.9 | 0 | 7.9 |
| Comparative | 1 | 14 | 84.6 | 17.4 | 29.7 | 14.0 |
| Example | 2 | 18 | 86.6 | 11.7 | 33.5 | 0.7 |
| | 3 | 14 | 87.3 | 6.2 | 56.6 | 0.7 |
| | 4 | 18 | 86.2 | 30.1 | 5.8 | 0.8 |
| | 5 | 15 | 87.4 | 12.1 | 37.7 | 2.3 |
| | 6 | 15 | 79.9 | 28.1 | 10.6 | 59.8 |
| | 7 | 11 | 70.3 | 53.4 | 3.3 | 92.7 |
| | 8 | 13 | 82.6 | 34.7 | 7.5 | 0.9 |

The polyimides of Examples 1 and 2 were shown to be excellent in terms of the colorless transparency in the present invention because of having a total light transmittance of 80% or more and a YI value (yellowness) of 5.0 or less. Moreover, these polyimides were shown to have extremely high colorless transparency also because of having a light transmittance of 70% at a wavelength of 400 nm and a haze value, as determined according to JIS K 7136, of 2 or less.

The colorless transparency of the polyimides of Examples 1 and 2 is very remarkable compared with the data of Reference Examples, which are commercially available products distributed on the market as polyimides.

Furthermore, the colorless transparency of the polyimides of Examples 1 and 2 is remarkable also compared with the polyimides of Comparative Examples 1 to 8 which have the same partial structure derived from a trimellitic anhydride ester of a bis(4-hydroxyphenyl)sulfone, thus revealing that a polyimide resin material for a colorless transparent processed product according to the present invention, the polyimide resin material containing a polyimide having a repeating unit represented by general formula (1), has a particular partial structure derived from a diamine to thereby exhibit a remarkable effect of colorless transparency.

1. A polyimide resin material for a colorless transparent processed product, the polyimide resin material comprising a polyimide having a repeating unit represented by general formula (1) below, 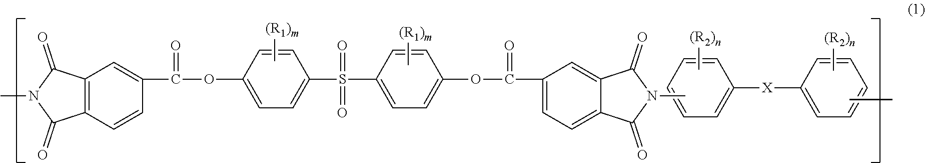
where X represents a direct bond or a sulfonyl group (—SO₂—), R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2.

2. A polyimide comprising a repeating unit represented by general formula (2) below, 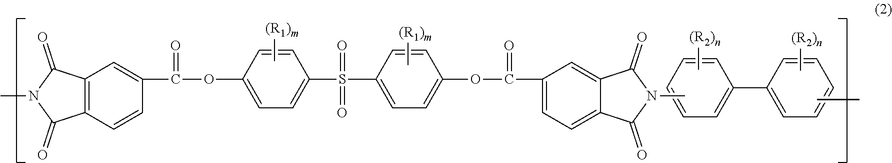
where R₁ and R₂ each independently represent a linear or branched alkyl group having 1 to 6 carbon atoms, a linear or branched alkyl halide group having 1 to 6 carbon atoms, or a halogen atom, and m and n each independently represent 0, 1, or 2.

3. A colorless transparent processed product obtained using the polyimide resin material according to claim 1.
